(19) United States
(12) Patent Application Publication
(10) Pub. No.: US 2026/0252137 A1
(43) Pub. Date: Aug. 27, 2026

(54) MULTIDIRECTIONAL INPUT DEVICE AND CONTROL HANDLE

(71) Applicant: SHENZHEN ZESUM TECHNOLOGY CO., LTD., Shenzhen (CN)

(72) Inventors: YUSHO NAKASE, Shenzhen (CN); SEN YANG, Shenzhen (CN); SHI-YING YANG, Shenzhen (CN); CHAO-XIAN CHEN, Shenzhen (CN)

(21) Appl. No.: 19/309,913

(22) Filed: Aug. 26, 2025

(30) Foreign Application Priority Data
Feb. 25, 2025 (CN) 202520312567.6

(51) Int. Cl. G05G 9/047; A63F 13/24; H01H 13/14; G05G 5/05; G06F 3/0338

(52) U.S. Cl. CPC G05G 9/04785; A63F 13/24; H01H 13/14; G05G 5/05; G05G 2009/04744; G05G 2009/04755; G05G 2009/04777; G06F 3/0338

(57) ABSTRACT

A multidirectional input device includes a housing, an operator, a rocker arm assembly, and magnetic sensing assembly. The housing defines a cavity, and the operator is pivotably disposed in the cavity. The rocker arm assembly includes a first rocker arm and a second rocker arm, at least one of the first rocker arm and the second rocker arm includes a rocker arm body and a rotating part disposed at both ends of the rocker arm body. The rotating part is disposed on the rotating part. The magnetic sensing assembly includes a magnetic member and a magnetic sensor, the magnetic member is disposed on the rotating part, the magnetic sensor is disposed on the electrical connecting member, and the magnetic member is configured to detect the rotation of the magnetic member. The magnetic member is in non-contact with the magnetic sensor, improving the service life of the sensor.

### TECHNICAL FIELD

The present disclosure relates to the technical field of non-contact sensing, and in particular, to a multidirectional input device and a control handle.

### BACKGROUND

In an existing multi-directional input device, operations in X-axis, Y-axis, and Z-axis directions are realized by rocking and pressing a joystick, and the direction and position changes of the joystick are sensed by a sensing element. However, when the joystick needs to be operated in the X-axis and Y-axis directions, a rotary sensing element is usually employed for sensing, but such a sensing element has low sensing accuracy, cannot meet the use requirements, and are easily affected by electromagnetic interference.

### SUMMARY

A multidirectional input device with high sensing accuracy is disclosed in the present disclosure. In addition, embodiments of the present disclosure also provides a control handle including the multidirectional input device.

An embodiment of the present disclosure provides a multidirectional input device, which includes a housing, an operator, a rocker arm assembly, two electrical connecting members, and at least one magnetic sensing assembly. The housing defines a cavity and an opening communicating with the cavity. At least part of the operator is pivotably disposed in the cavity. The operator includes an operating body, the operating body includes a first end extending out of the cavity from the opening. At least part of the rocker arm assembly is located inside the housing and is rotatably connected to the housing, the operator is connected to the rocker arm assembly. The rocker arm assembly includes a first rocker arm and a second rocker arm, the first rocker arm and the second rocker arm are configured to rotate with the operator around two directions perpendicular to each other, and at least one of the first rocker arm and the second rocker arm includes a rocker arm body and a rotating part disposed at both ends of the rocker arm body. The two electrical connection members are located outside the housing. Each magnetic sensing assembly includes a magnetic member and a magnetic sensor, the magnetic member is connected to the rotating part of the first rocker arm or the second rocker arm, the magnetic sensor is fixed to one of the two electrical connection members and is spaced apart from the magnetic member, the magnetic sensor is configured to detect rotation of the first rocker arm or the second rocker arm through the magnetic member.

The magnetic sensor is disposed on the electrical connection member , the magnetic member is disposed on the rotating part , and the magnetic member and the magnetic sensor are spaced apart from each other, so that the magnetic member is in non-contact with the magnetic sensor , the service life of the magnetic sensor can be improved, and the problem that the magnetic sensor is easily interfered by foreign objects can be improved. The structure of the multidirectional input device is simplified. The non-contact design between the magnetic member and the magnetic sensor solves the problem that the existing multi-directional input device has low precision when using rotatory electrical components and is easily affected by electromagnetic interference. This design allows for more accurate and reliable multi-directional operations.

In some embodiment of the present disclosure, each of the two electrical connection members includes a cover, a circuit board, and a connecting portion, the cover and the connecting portion are integrally formed, the circuit board is disposed between the cover and the connecting portion, the magnetic sensor is disposed on a side of the circuit board facing away from the rotating part and is electrically connected to the circuit board, and the connecting portion is configured to be fixed to the housing and connected to the rotating part.

In some embodiment of the present disclosure, the rotating part is provided with a latching protrusion, a side of the connecting portion facing the rotating part defines a latching groove, at least part of the latching protrusion is snapped with the latching groove.

In some embodiment of the present disclosure, the rotating part defines a placement groove, at least part of the magnetic member is disposed in the placement groove, and centers of the magnetic member and the magnetic sensor are distributed along an axial direction of the rotating part.

In some embodiment of the present disclosure, the rocker arm body defines a sliding groove, an extension direction of at least part of the sliding groove is parallel to the axial direction of the two rotating part, the first end passes through the sliding groove and is slidably disposed in the sliding groove, the first end is configured to drive the second rocker arm to rotate relative to the housing when moving along the sliding groove of the first rocker arm, the first end is further configured to drive the first rocker arm to rotate relative to the housing when moving along the sliding groove of the second rocker arm.

In some embodiment of the present disclosure, the housing includes a base and a limiting member, the base defines a groove, the rotating part is rotatably disposed in the groove, the limiting member is fixed to the base, the limiting member defines a limiting hole, the operator further includes a protruding portion disposed around a periphery of the operating body, at least part of the protruding portion is embedded in the limiting opening, and the first end passes through the limiting hole and extends towards the opening.

In some embodiment of the present disclosure, the multidirectional input device further includes a pressing assembly, wherein the pressing assembly includes a pressing member and a pressing switch, the pressing member is movably disposed on the base and located at a lower end of the protruding portion, the pressing member includes an abutting portion and a pressing portion, the abutting portion is disposed at the lower end of the protruding portion and abuts against the lower end of the protruding portion, the pressing portion extends toward an exterior of the housing and is located at an upper end of the pressing switch, the pressing switch is disposed on the housing, the pressing member is configured to trigger the pressing switch when the operating body is pressed, the protruding portion includes a second end, and the second end is configured to press against the pressing portion to trigger the pressing switch when the operating body is pressed.

In some embodiment of the present disclosure, the multidirectional input device further includes a resetting mechanism disposed in the cavity and elastically abutting against the protruding portion, the resetting mechanism is configured to reset the operator when at least part of the operator is rocked in the cavity, the resetting mechanism includes an elastic member and a pressing plate, the elastic member is disposed in the limiting member, the pressing plate is disposed at an end of the elastic member close to the limiting hole, the elastic member holds the pressing plate against the lower end of the protruding portion, and the protruding portion is configured to abut against a surface of the pressing plate facing the limiting hole.

An embodiment of the present disclosure provides a control handle including the above multidirectional input device.

### BRIEF DESCRIPTION OF THE DRAWINGS

FIG. 1 is a perspective view of a multidirectional input device according to an embodiment of the present disclosure.

FIG. 2 is an exploded view of the multidirectional input device of FIG. 1.

FIG. 3 is a cross-sectional view of the multidirectional input device taken along line IV-IV of FIG. 1.

FIG. 4 is an enlarged view of part A from FIG. 3.

FIG. 5 is an enlarged view of part B from FIG. 3.

FIG. 6 is a schematic block diagram of a control handle according to an embodiment of the present disclosure.

The present disclosure will be further described with reference to the accompanying drawings in the following specific embodiments.

### DETAILED DESCRIPTION

Technical solutions in embodiments of the present disclosure will be described below in conjunction with the accompanying drawings in the embodiments of the present disclosure. Obviously, the described embodiments are only some embodiments of the present disclosure, but not all embodiments.

It should be noted that when a component is deemed as being “connected to” another component, it may be directly connected to the another component, or there may be a component disposed in between. When a component is deemed as being “disposed” on another component, it may be directly disposed on the another component, or there may be a component disposed in between.

Unless otherwise defined, all technical and scientific terms used herein shall have the same meanings as commonly understood by those skilled in the art to which this application relates. The terms used herein are intended to merely describe the specific embodiments rather than to limit this application. The term “and/or” as used herein includes any and all combinations of one or more related listed items.

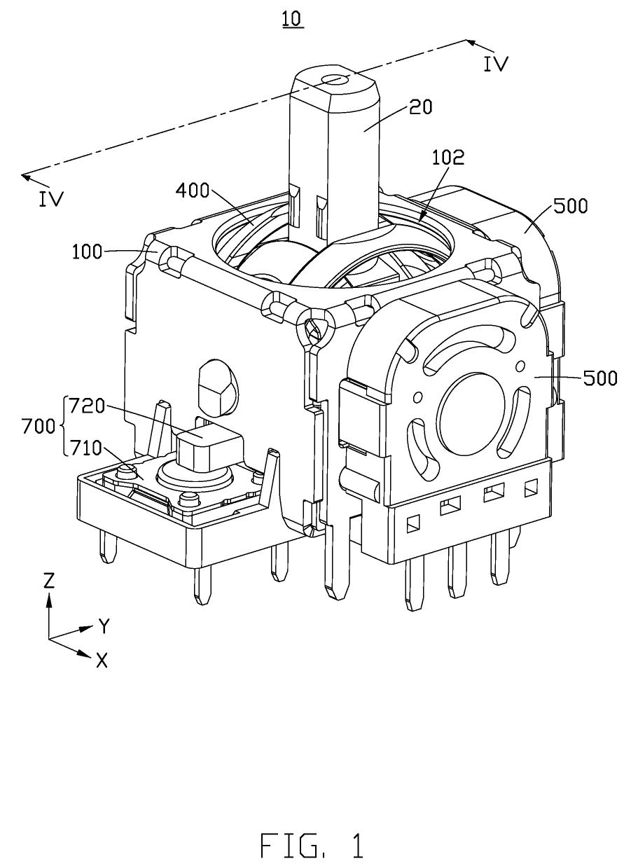

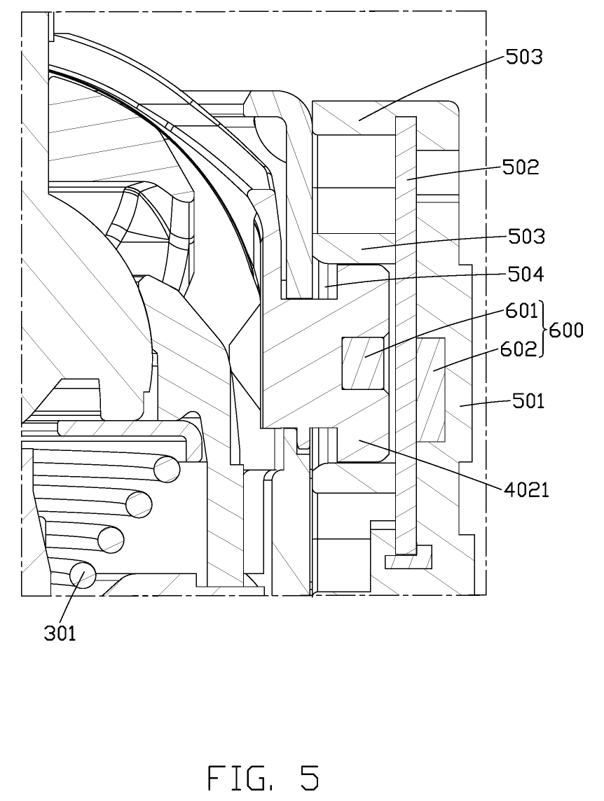

Referring to FIGS. 1 to 5, an embodiment of the present disclosure provides a multidirectional input device 10. The multidirectional input device 10 incudes a housing 100, an operator 20, a rocker arm assembly 400, two electrical connection members 500, and two magnetic sensing assemblies 600. The housing 100 defines a cavity 101 therein, and the housing 100 defines an opening 12 communicating with the cavity 101. At least part of the operator 20 is pivotably disposed in the cavity 101. The operator 20 includes an operating body 200. The operating body 200 includes a first end 201, and the first end 201 extends out of the cavity 101 from the opening 102.

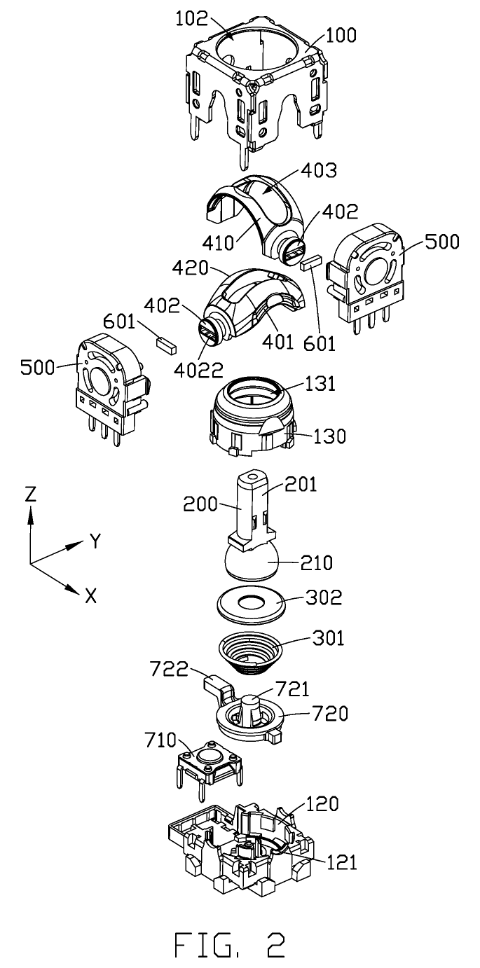

At least part of the rocker arm assembly 400 is located inside the housing 100 and is rotatably connected to the housing 100, and the operator 20 is connected to the rocker arm assembly 400 in a drive manner. The rocker arm assembly 400 includes a first rocker arm 410 and a second rocker arm 420, and the first rocker arm 410 and the second rocker arm 420 are configured to rotate with the operator 20 around two directions perpendicular to each other. At least one of the first rocker arm 410 and the second rocker arm 420 includes a rocker arm body 401 and a rotating part 402 disposed at both ends of the rocker arm body 401. The two electrical connection members 500 are located outside the housing 100. Each magnetic sensing assembly 600 includes a magnetic member 601 and a magnetic sensor 602. The magnetic member 601 is connected to the rotating part 402, and the magnetic sensor 602 is fixed to the electrical connection member 500 and is spaced apart from the magnetic member 601. The magnetic sensor 602 is configured to detect the rotation of the first rocker arm 410 or the second rocker arm 420 through the magnetic member 60. As shown in FIG. 2, optionally, when the first rocker arm 410 rotates around a direction parallel to the Y-axis, the magnetic sensor 602 corresponding to the magnetic member 601 which is fixed to the first rocker arm 410 detects the rotation of the first rocker arm 410, and when the second rocker arm 420 rotates around a direction parallel to the X-axis, the magnetic sensor 602 corresponding to the magnetic member 601 which is fixed to the second rocker arm 420 detects the rotation of the second rocker arm 420. Therefore, when the operator 20 is rocked in the X-axis direction, the magnetic sensor 602 corresponding to the magnetic member 601 which is fixed to the second rocker arm 420 detects the rotation of the second rocker arm 420. When the operator 20 is rocked in the Y-axis direction, the magnetic sensor 602 corresponding to the magnetic member 601 which is fixed to the second rocker arm 420 detects the rotation of the second rocker arm 420.

The magnetic sensor 602 is disposed on the electrical connection member 500, the magnetic member 601 is disposed on the rotating part 402, and the magnetic member 601 and the magnetic sensor 602 are spaced apart from each other, so that the magnetic member 601 is in non-contact with the magnetic sensor 602, the service life of the magnetic sensor 602 can be improved, and the problem that the magnetic sensor 602 is easily interfered by foreign objects can be improved. The structure of the multidirectional input device 10 is simplified. The non-contact design between the magnetic member 601 and the magnetic sensor 602 solves the problem that the existing multi-directional input device has low precision when using rotatory electrical components and is easily affected by electromagnetic interference. This design allows for more accurate and reliable multi-directional operations.

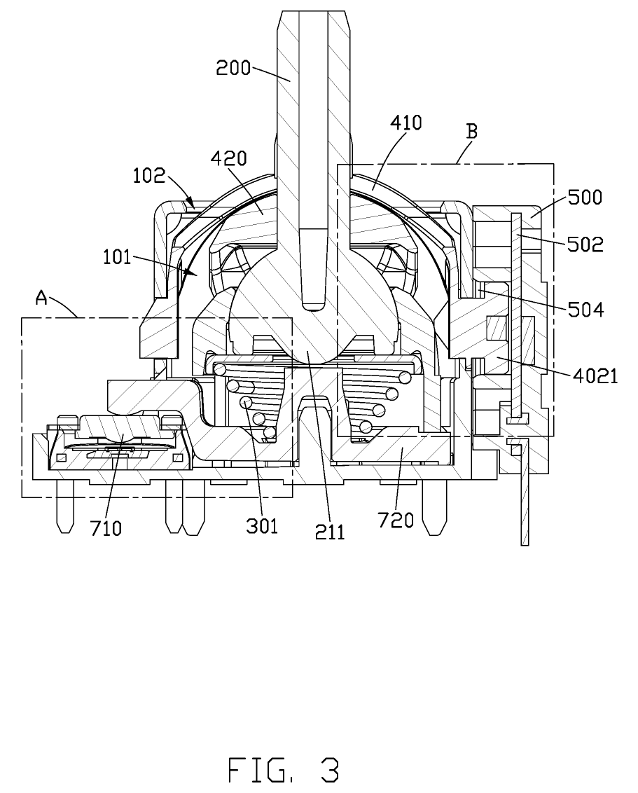

Referring to FIGS. 2 and 3, in some embodiments of the present disclosure, the electrical connection member 500 includes a cover 501, a circuit board 502, and a connecting portion 503. The cover 501 and the connecting portion 503 are integrally formed, and the circuit board 502 is disposed between the cover 501 and the connecting portion 503. The magnetic sensor 602 is disposed on a side of the circuit board 502 facing away from the rotating part 402 and is electrically connected to the circuit board 502. The connecting portion 503 is configured to be fixed to the housing 100 and connected to the rotating part 402. By integrally forming the cover 501 and the connecting portion 503, the stability and reliability of the electrical connection member 500 are ensured. The circuit board 502 is disposed between the cover 501 and the connecting portion 503, ensuring the stability and protection of the circuit board 502, and avoiding interference of the external environment to the circuit board 502. The magnetic sensor 602 is disposed on a side of the circuit board 502 facing away from the rotating part 402, further enhancing the anti-interference ability of the sensor, and ensuring the stability and accuracy of the detection signals. The connecting portion 503 is fixed to the housing 100 and connected to the rotating part 402, thereby ensuring a firm connection between the rotating part 402 and the housing 100, reducing the impact of vibration and looseness, and thus improving the overall detection accuracy and service life.

Referring to FIGS. 2 to 3, in some embodiments of the present disclosure, the rotating part 402 is provided with a latching protrusion 4021. A latching groove 504 is defined on a side of the connecting portion 503 facing the rotating part 402, and at least part of the latching protrusion 4021 is snapped with the latching groove 504. By providing the latching protrusion 4021 on a peripheral side of the rotating part 402 and providing the latching groove 504 on the side of the connecting portion 503 facing the rotating part 402, a reliable connection between the rotating part 402 and the connecting portion 503 is achieved. The snap connection between the latching protrusion 4021 and the latching groove 504 ensures the stability and consistency between the rotating part 402 and the connecting portion 503 during the rotation process can be ensured, avoiding detection errors caused by looseness or offset. Additionally, this design simplifies the assembly process, improves production efficiency, and enhances the stability of the overall structure, ensuring the high precision and reliability of the multidirectional input device 10.

Referring to FIG. 2, in some embodiments of the present disclosure, the rotating part 402 defines a placement groove 4022, and at least part of the magnetic member 601 is disposed in the placement groove 4022. Centers of the magnetic member 601 and the magnetic sensor 602 are distributed along an axial direction of the rotating part 402. By providing the placement groove 4022 in the rotating part 402 and disposing the magnetic member 601 in the placement groove 4022, the stability and accuracy of the magnetic member 601 are ensured. The rotation centers of the magnetic member 601 and the magnetic sensor 602 are distributed along the axial direction of the rotating part 402, ensuring that the magnetic sensor 602 can accurately detect the rotation of the magnetic member 601. Additionally, this design further optimizes the layout of the magnetic sensing assembly 600, improves the sensitivity and accuracy of the detection, and ensures the high precision and reliability of the multidirectional input device 10.

Referring to FIG. 2, in some embodiments of the present disclosure, a sliding groove 403 is defined on the rocker arm body 401. An extension direction of at least part of the sliding groove 403 is parallel to the axial direction of the rotating part 402. The first end 201 passes through the sliding groove 403 and is slidably disposed in the sliding groove 403. The first end 201 is configured to drive the second rocker arm 420 to rotate relative to the housing 100 when moving along the sliding groove 403 of the first rocker arm 410. The first end 201 is also configured to drive the first rocker arm 410 to rotate relative to the housing 100 when moving along the sliding groove 403 of the second rocker arm 420. The rocker arm body 401 defines the sliding groove 403, and the first end 201 is slidably disposed in the sliding groove 403, so that the movement of the rocker arm assembly 400 can be accurately controlled. When the first end 201 moves along the sliding groove 403 of the first rocker arm 410, the second rocker arm 420 is driven to rotate relative to the housing 100. Similarly, when the first end 201 moves along the sliding groove 403 of the second rocker arm 420, the first rocker arm 410 is driven to rotate relative to the housing 100. This design ensures smooth and accurate operation of the rocker arm assembly 400 during multi-directional operations. Additionally, the sliding groove 403 also prevents any misalignment or loosening of the rocker arm assembly 400, improving the operation accuracy and stability of the multi-directional input device 10.

Referring to FIGS. 3 to 5, in some embodiments of the present disclosure, the housing 100 includes a base 120 and a limiting member 130. The base 120 defines a groove 121, and the rotating part 402 is rotatably disposed in the groove 121. The limiting member 130 is fixed to the base 120, and the limiting member 130 defines a limiting hole 131. The operator 20 also includes a protruding portion 210 disposed around a periphery of the operating body 200, and at least part of of the protruding portion 210 is embedded in the limiting hole 131, and the first end 201 passes through the limiting hole 131 and extends toward the opening 102. By designing the housing 100 such that the base 120 and the limiting member 130 cooperate with each other, the stability and reliability of the housing 100 are ensured. The base 120 defines the groove 121, and the rotating part 402 is rotatably disposed in the groove 121, ensuring the stability and accuracy of the rotating part 402. The limiting member 130 is fixed to the base 120 and defines the limiting hole 131, ensuring the accuracy of the movement range and position of the protruding portion 210. A resetting mechanism 300 includes an elastic member 301 and a pressing plate 302. The elastic member 301 is arranged in the limiting member 130, and the pressing plate 302 is disposed at an end of the elastic member 301 close to the limiting hole 131, which ensures that the operator 20 can automatically reset after being rocked, avoiding the operator 20 from being in a state of deviation from the original position for a long time, and improving the convenience and efficiency of operation. The elastic member 301 is arranged in the limiting member 130, the pressing plate 302 is disposed at an end of the elastic member 301 close to the limiting hole 131, and the elastic member 301 holds the pressing plate 302 against the lower end of the protruding portion 210, so as to ensure a stable contact between the pressing plate 302 and the protruding portion 210. The protruding portion 210 is configured to abut against the surface of the pressing plate 302 facing the limiting hole 131, ensuring the efficiency and reliability of the resetting mechanism 300. Optionally, the protruding portion 210 is hemispherical. By providing the limiting hole 131 and the hemispherical structure of the protruding portion 210, the operator 20 can maintain a non-directional and uniform operating feel within a full range of 360 degrees, and the operator 20 can have high precision reset characteristics.

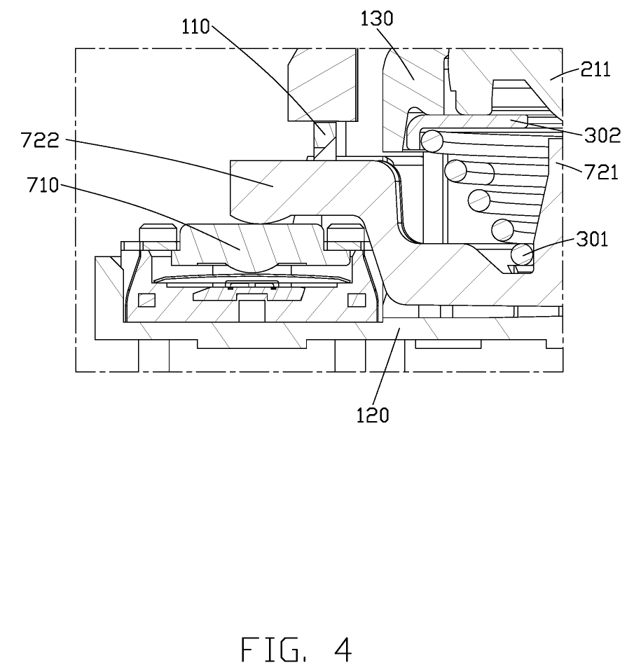

Referring to FIGS. 3 and 4, in some embodiments of the present disclosure, the multidirectional input device 10 further includes a pressing assembly 700. The pressing assembly 700 includes a pressing member 720 and a pressing switch 710. The pressing member 720 is movably disposed on the base 120 and located at a lower end of the protruding portion 210, and the pressing member 720 includes an abutting portion 721 and a pressing portion 722. The abutting portion 721 is disposed at the lower end of the protruding portion 210 and abuts against the lower end of the protruding portion 210, and the pressing portion 722 extends toward an exterior of the housing 100 and is located at an upper end of the pressing switch 710. The pressing switch 710 is disposed on the housing 100, and the pressing member 720 is configured to trigger the pressing switch 710 when the operating body 200 is pressed. The pressing member 720 is movably disposed on the base 120 and located at the lower end of the protruding portion 210, thereby ensuring the stability and flexibility of the pressing assembly 700. The abutting portion 721 is disposed at the lower end of the protruding portion 210 and abuts against the lower end of the protruding portion 210, thereby ensuring the stability of the protruding portion 210 and the precise contact between the pressing member 720 and the protruding portion 210. The pressing portion 722 extends toward the exterior of the housing 100 and is located at the upper end of the pressing switch 710, thereby ensuring the sensitivity and reliability of the pressing operation. The pressing member 720 is configured to trigger the pressing switch 710 when the operating body 200 is pressed, thereby improving the operational flexibility and functionality of the multidirectional input device 10. Since there is no carbon film to absorb water, the problem of abnormal ring resistance value under high temperature and high humidity can be solved. The protruding portion 210 includes a second end 211, which is configured to press against the pressing portion 722 to trigger the pressing switch 710 when the operating body 200 is pressed. It is ensured that the operating body 200 can accurately trigger the pressing switch 710 during the pressing process, avoiding the situation of false touch or misjudgment. This design simplifies the structure of the pressing assembly 700 while improving its sensitivity and stability, thereby ensuring high efficiency and reliability during pressing operations of the multidirectional input device 10.

Referring to FIGS. 3 and 4, in some embodiments of the present disclosure, the multidirectional input device 10 further includes the resetting mechanism 300. The resetting mechanism 300 is disposed in the cavity 101 and elastically abuts against the protruding portion 210. The resetting mechanism 300 is configured to reset the operator 20 when at least part of the operator 20 is rocked in the cavity 101. The resetting mechanism 300 includes the elastic member 301 and the pressing plate 302. The elastic member 301 is disposed in the limiting member 130. The pressing plate 302 is disposed at the end of the elastic member 301 close to the limiting hole 131. The elastic member 301 holds the pressing plate 302 against the lower end of the protruding portion 210. The protruding portion 210 is configured to abut against the surface of the pressing plate 302 facing the limiting hole 131.

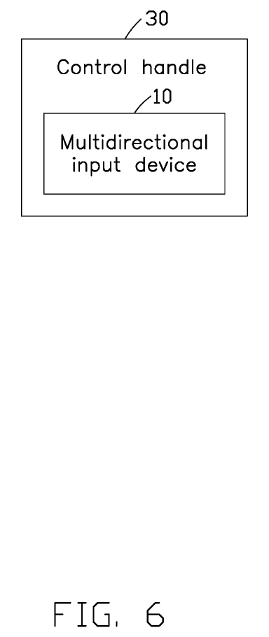

Referring to FIG. 6, the embodiment of the present disclosure further provides a control handle 30. The control handle 30 includes the aforementioned multidirectional input device 10. By incorporating the multidirectional input device 10 to the control handle 30, the application range and functionality of the handle are further expanded. The control handle 30 includes the multi-directional input device 10, which ensures accuracy and reliability operation of the handle in multiple directions, and improves the user's operating experience. This design enables the control handle 30 to adapt to more types of operating requirements, improving its flexibility and practicality, and also providing higher precision and reliability for games, virtual reality and other fields.

The above are only embodiments of the present disclosure which do not limit the patent scope of the present disclosure, and any equivalent structure or equivalent process made based on the description and drawings of the present disclosure, or those directly or indirectly applied in other related technical fields, are all included in the scope of patent protection of the present disclosure.

What is claimed is:

1. A multidirectional input device comprising:
a housing defining a cavity and an opening communicating with the cavity;
an operator, at least part of the operator being pivotably disposed in the cavity, the operator comprising an operating body, the operating body comprising a first end extending out of the cavity from the opening;
a rocker arm assembly, at least part of the rocker arm assembly being located inside the housing and being rotatably connected to the housing, wherein the operator is connected to the rocker arm assembly, the rocker arm assembly comprises a first rocker arm and a second rocker arm, the first rocker arm and the second rocker arm are configured to rotate with the operator around two directions perpendicular to each other, and at least one of the first rocker arm and the second rocker arm comprises a rocker arm body and a rotating part disposed at both ends of the rocker arm body;
two electrical connection members located outside the housing;
at least one magnetic sensing assembly, each magnetic sensing assembly comprising a magnetic member and a magnetic sensor, wherein the magnetic member is connected to the rotating part of the first rocker arm or the second rocker arm, the magnetic sensor is fixed to one of the two electrical connection members and is spaced apart from the magnetic member, and the magnetic sensor is configured to detect rotation of the first rocker arm or the second rocker arm through the magnetic member.

2. The multidirectional input device according to claim 1, wherein each of the two electrical connection members comprises a cover, a circuit board, and a connecting portion, the cover and the connecting portion are integrally formed, the circuit board is disposed between the cover and the connecting portion, the magnetic sensor is disposed on a side of the circuit board facing away from the rotating part and is electrically connected to the circuit board, and the connecting portion is configured to be fixed to the housing and connected to the rotating part.

3. The multidirectional input device according to claim 2, wherein the rotating part is provided with a latching protrusion, a side of the connecting portion facing the rotating part defines a latching groove, at least part of the latching protrusion is snapped with the latching groove.

4. The multidirectional input device according to claim 1, wherein the rotating part defines a placement groove, at least part of the magnetic member is disposed in the placement groove, and centers of the magnetic member and the magnetic sensor are distributed along an axial direction of the rotating part.

5. The multidirectional input device according to claim 4, wherein the rocker arm body defines a sliding groove, an extension direction of at least part of the sliding groove is parallel to the axial direction of the two rotating part, the first end passes through the sliding groove and is slidably disposed in the sliding groove, the first end is configured to drive the second rocker arm to rotate relative to the housing when moving along the sliding groove of the first rocker arm, and the first end is further configured to drive the first rocker arm to rotate relative to the housing when moving along the sliding groove of the second rocker arm.

6. The multidirectional input device according to claim 1, wherein the housing comprises a base and a limiting member, the base defines a groove, the rotating part is rotatably disposed in the groove, the limiting member is fixed to the base, the limiting member defines a limiting hole, the operator further comprises a protruding portion disposed around a periphery of the operating body, at least part of the protruding portion is embedded in the limiting opening, and the first end passes through the limiting hole and extends towards the opening.

7. The multidirectional input device according to claim 6, further comprising a pressing assembly, wherein the pressing assembly comprises a pressing member and a pressing switch, the pressing member is movably disposed on the base and located at a lower end of the protruding portion, the pressing member comprises an abutting portion and a pressing portion, the abutting portion is disposed at the lower end of the protruding portion and abuts against the lower end of the protruding portion, the pressing portion extends toward an exterior of the housing and is located at an upper end of the pressing switch, the pressing switch is disposed on the housing, the pressing member is configured to trigger the pressing switch when the operating body is pressed, the protruding portion comprises a second end, and the second end is configured to press against the pressing portion to trigger the pressing switch when the operating body is pressed.

8. The multidirectional input device according to claim 7, further comprising a resetting mechanism disposed in the cavity and elastically abutting against the protruding portion, the resetting mechanism is configured to reset the operator when at least part of the operator is rocked in the cavity, the resetting mechanism comprises an elastic member and a pressing plate, the elastic member is disposed in the limiting member, the pressing plate is disposed at an end of the elastic member close to the limiting hole, the elastic member holds the pressing plate against the lower end of the protruding portion, and the protruding portion is configured to abut against a surface of the pressing plate facing the limiting hole.

9. The multidirectional input device according to claim 1, wherein each of the first rocker arm and the second rocker arm comprises the rocker arm body and the rotating part disposed at both ends of the rocker arm body, the multidirectional input device comprises two magnetic sensing assemblies, magnetic members of the two magnetic sensing assemblies are respectively connected to the rotating part of the first rocker arm and the rotating part of the second rocker arm, and the magnetic sensors of the two magnetic sensing assemblies are respectively fixed to the two electrical connection members.

10. A control handle comprising a multidirectional input device, the multidirectional input device comprising:
a housing defining a cavity and an opening communicating with the cavity;
an operator, at least part of the operator being pivotably disposed in the cavity, the operator comprising an operating body, the operating body comprising a first end extending out of the cavity from the opening;
a rocker arm assembly, at least part of the rocker arm assembly being located inside the housing and being rotatably connected to the housing, wherein the operator is connected to the rocker arm assembly, the rocker arm assembly comprises a first rocker arm and a second rocker arm, the first rocker arm and the second rocker arm are configured to rotate with the operator around two directions perpendicular to each other, and at least one of the first rocker arm and the second rocker arm comprises a rocker arm body and a rotating part disposed at both ends of the rocker arm body;
two electrical connection members located outside the housing;
at least one magnetic sensing assembly, each magnetic sensing assembly comprising a magnetic member and a magnetic sensor, wherein the magnetic member is connected to the rotating part of the first rocker arm or the second rocker arm, the magnetic sensor is fixed to one of the two electrical connection members and is spaced apart from the magnetic member, and the magnetic sensor is configured to detect rotation of the first rocker arm or the second rocker arm through the magnetic member.

11. The control handle according to claim 10, wherein each of the two electrical connection members comprises a cover, a circuit board, and a connecting portion, the cover and the connecting portion are integrally formed, the circuit board is disposed between the cover and the connecting portion, the magnetic sensor is disposed on a side of the circuit board facing away from the rotating part and is electrically connected to the circuit board, and the connecting portion is configured to be fixed to the housing and connected to the rotating part.

12. The control handle according to claim 11, wherein the rotating part is provided with a latching protrusion, a side of the connecting portion facing the rotating part defines a latching groove, at least part of the latching protrusion is snapped with the latching groove.

13. The control handle according to claim 10, wherein the rotating part defines a placement groove, at least part of the magnetic member is disposed in the placement groove, and centers of the magnetic member and the magnetic sensor are distributed along an axial direction of the rotating part.

14. The control handle according to claim 13, wherein the rocker arm body defines a sliding groove, an extension direction of at least part of the sliding groove is parallel to the axial direction of the two rotating part, the first end passes through the sliding groove and is slidably disposed in the sliding groove, the first end is configured to drive the second rocker arm to rotate relative to the housing when moving along the sliding groove of the first rocker arm, and the first end is further configured to drive the first rocker arm to rotate relative to the housing when moving along the sliding groove of the second rocker arm.

15. The control handle according to claim 10, wherein the housing comprises a base and a limiting member, the base defines a groove, the rotating part is rotatably disposed in the groove, the limiting member is fixed to the base, the limiting member defines a limiting hole, the operator further comprises a protruding portion disposed around a periphery of the operating body, at least part of the protruding portion is embedded in the limiting opening, and the first end passes through the limiting hole and extends towards the opening.

16. The control handle according to claim 15, wherein the multidirectional input device further comprises a pressing assembly, wherein the pressing assembly comprises a pressing member and a pressing switch, the pressing member is movably disposed on the base and located at a lower end of the protruding portion, the pressing member comprises an abutting portion and a pressing portion, the abutting portion is disposed at the lower end of the protruding portion and abuts against the lower end of the protruding portion, the pressing portion extends toward an exterior of the housing and is located at an upper end of the pressing switch, the pressing switch is disposed on the housing, the pressing member is configured to trigger the pressing switch when the operating body is pressed, the protruding portion comprises a second end, and the second end is configured to press against the pressing portion to trigger the pressing switch when the operating body is pressed.

17. The control handle according to claim 16, wherein the multidirectional input device further comprises a resetting mechanism disposed in the cavity and elastically abutting against the protruding portion, the resetting mechanism is configured to reset the operator when at least part of the operator is rocked in the cavity, the resetting mechanism comprises an elastic member and a pressing plate, the elastic member is disposed in the limiting member, the pressing plate is disposed at an end of the elastic member close to the limiting hole, the elastic member holds the pressing plate against the lower end of the protruding portion, and the protruding portion is configured to abut against a surface of the pressing plate facing the limiting hole.

18. The control handle according to claim 10, wherein each of the first rocker arm and the second rocker arm comprises the rocker arm body and the rotating part disposed at both ends of the rocker arm body, the multidirectional input device comprises two magnetic sensing assemblies, magnetic members of the two magnetic sensing assemblies are respectively connected to the rotating part of the first rocker arm and the rotating part of the second rocker arm, and the magnetic sensors of the two magnetic sensing assemblies are respectively fixed to the two electrical connection members.
